(19) United States
(12) Patent Application Publication
(10) Pub. No.: US 2017/0031791 A1
(43) Pub. Date: Feb. 2, 2017

(54) MAINTAINING A PARITY-INCONSISTENT TABLE TO IDENTIFY STRIPES AFFECTED BY A WRITE HOLE EFFECT

(71) Applicant: Futurewei Technologies, Inc., Plano, TX (US)

(72) Inventor: Weimin Pan, Spring, TX (US)

(21) Appl. No.: 14/810,264

(22) Filed: Jul. 27, 2015

(51) Int. Cl. G06F 11/20; G06F 11/16

(52) U.S. Cl. CPC G06F 11/2069; G06F 11/1662

(57) ABSTRACT

A method performed by a redundant array of independent disks (RAID) controller includes retrieving, from a table, information identifying a stripe in a RAID following a system crash in the RAID. Data was to be written to the stripe in response to a write command and prior to the system crash. The information identifies respective data arrays and a respective parity drive identified by the stripe. The information is generated and written to the table prior to writing the data to the respective disk arrays and the respective parity drive identified by the stripe, and prior to the system crash. For the identified stripe, parity data is determined using data stored in the respective data arrays identified by the stripe. The determined parity data is written to the parity drive identified by the stripe.

### BACKGROUND

Redundant Arrays of Independent Disks (RAID) technology is implemented in mass storage of data. A RAID array is a logical structure including multiple RAID disks that work together to improve storage reliability and performance. One implementation of a RAID technique implements a mirrored array of disks whose aggregate capacity is equal to that of the smallest of its member disks. Another implementation of a RAID technique implements a striped array whose aggregate capacity is approximately the sum of the capacities of its members. RAID technology can provide benefits compared to individual disks such as improved I/O performance due to load balancing, improved data reliability, improved storage management, to name a few.

Several classifications or levels of RAID are known—RAID 0, RAID 1, RAID 5, RAID 6. Certain RAID arrays, for example, RAID 1, RAID 5, RAID 6, implement added computations for fault tolerance by calculating the data into drives and storing the results on the third. The parity is computed by an exclusive OR Boolean operation (XOR). When a drive fails, the data in the drive that has been lost can be recovered from the other two drives using the computed parity.

In some instances, a system may crash or power may be lost with multiple writes outstanding to the drives. Some but not all of the write operations may have completed, resulting in parity inconsistency. Such a parity inconsistency due to a system crash or power loss is called a write hole effect.

### SUMMARY

This specification describes solving parity RAID write hole effects.

Certain aspects of the subject matter described here can be implemented as a method performed by a redundant array of independent disks (RAID) controller. Following a system crash in a redundant array of independent disks (RAID), information stored in a table, the information identifying at least one stripe from among multiple stripes in the RAID is retrieved from the table. Data was to be written to the at least one stripe in response to the write command and prior to the system crash. The information identifies respective data arrays and a respective parity drive identified by the at least one stripe. The information is generated prior to writing the data to the respective data arrays and the respective parity drive identified by the at least one stripe and prior to the system crash. The parity data for the identified at least one stripe can be reconstructed using the information retrieved from the table. For the identified at least one stripe, parity data that was to be written to the respective parity drive in response to the write command and prior to the system crash is determined using data stored in the respective data arrays.

Certain aspects of the subject matter described here can be implemented as a redundant array of independent disks (RAID) controller configured to perform operations described here. Certain aspects of the subject matter described here can be implemented as a computer-readable medium storing instructions executable by one or more processors to perform operations described here. Certain aspects of the subject matter described here can be implemented as a system including one or more processors and a computer-readable medium storing instructions executable by the one or more processors to perform operations described here.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of a RAID array.

FIG. 2 is a schematic diagram showing determination of the parity data to be written to the parity drive of the RAID array of FIG. 1.

FIG. 3 is a schematic diagram showing updating a parity data in a parity drive in the RAID array of FIG. 1.

FIG. 4 is a schematic diagram showing recovering data in a disk drive in the RAID array of FIG. 1.

FIG. 5 is a schematic diagram of a parity-inconsistent table implemented to address a write hole effect in the RAID array of FIG. 1.

FIG. 6 is a flowchart of an example of a process of solving a write hole effect in a RAID array.

### DETAILED DESCRIPTION

The write hole effect can happen in a RAID array if the system crashes, for example, due to a power failure while executing a write command. The write hole effect can occur in all array types, for example, RAID 1, RAID 5, RAID 6, or other array types. A write hole effect can make it impossible to determine which data blocks or parity blocks have been written to the disks and which have not. When power failure occurs in the middle of executing a write command, parity data for a stripe (described later) will not match the rest of the data in the stripe. Also, it cannot be determined with confidence whether the parity data or data in the data blocks is incorrect.

If the parity (in RAID 5) or the mirror copy (in RAID 1) is not written correctly, the error would go unnoticed until one of the array member disks fails or data cannot be read from an array member disk. If the disk fails, the failed disk will need to be replaced, and the RAID array will need to be rebuilt. If the data cannot be read from a disk, the data will be regenerated from the rest of the disks in an array. In such situations, one of the blocks would be recovered incorrectly, causing data integrity issues.

One technique to avoid the write hole effect in a RAID array is to use an un-interruptible power supply (UPS) for the entire RAID array. Another technique is to implement parity checking in every startup to identify inconsistent stripes and fix parity. However, parity checking for an entire storage array can be time-consuming. A host, who wants to access volumes in the RAID array, will be inconvenienced by the downtime for parity checking. In addition, the host may access volumes before parity checking has been completed, causing potential data integrity issues until parity checking has been completed.

This specification describes an alternative technique to avoid the write hole effect in a RAID array. As described below, a parity-inconsistent table is implemented to track each ongoing write operation. A parity-inconsistent entry is set in the table for the stripe being written. The entry is cleared after the write operation has been successfully completed. The parity-inconsistent table is stored on a persistent memory that can survive during power loss. If a power loss occurs during the write operations, then stripes with inconsistent parity have entries in the parity-inconsistent table. During the next startup, only those stripes with entries in the parity-inconsistent table need be identified, thereby negating a need to perform parity checking for the entire storage array.

To fix the parity-inconsistency in a stripe identified by the parity-inconsistent table, the parity data for the stripe can be determined using the data written to the disk drives in that stripe. For example, the parity data can be determined by performing exclusive Boolean OR operations as described below. Once the stripe has become parity-consistent, the parity data can be used to regenerate data in blocks in that stripe. Moreover, because the write operation to the stripe failed, data in some (or none) of the data blocks in the stripe may be new data that was to be written while data in other data blocks in the stripe may be old data that was previously written (or a combination of them). Regardless, the parity data can be calculated for the stripe and the stripe made parity-consistent as long as the data can be read from the data blocks.

After fixing parity inconsistencies identified by the entries in the parity-inconsistent table, the RAID array can be brought online and host requests to write data can be processed. In this manner, a time consumed for parity checking can be significantly reduced, making the RAID array available to the host sooner and reducing the impact on startup time.

Example Structure of a RAID Array

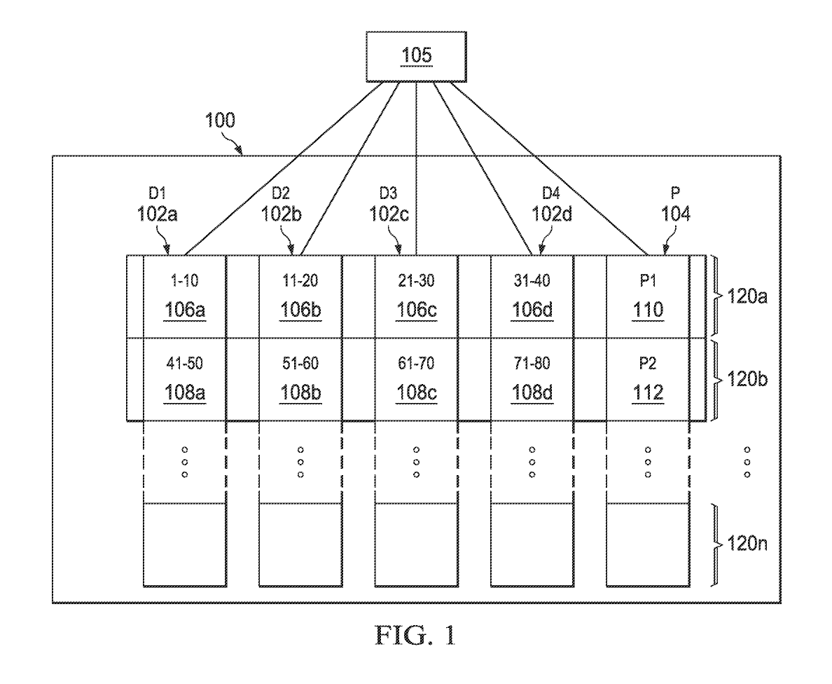

FIG. 1 is a schematic diagram of a RAID array 100. The RAID array 100 includes multiple data drives (for example, a first data drive 102a, a second data drive 102b, a third data drive 102c, a fourth data drive 102d) and a parity drive 104. In some implementations, the RAID array 100 can be any RAID array that implements a parity drive, for example, RAID 4, RAID 5, RAID 6, R50, R60. The RAID array 100 includes a RAID controller 105 that is operatively coupled to each data drive, each parity drive and to the parity-inconsistent table (described later).

Each data drive can store data blocks identified by respective logical block addresses (LBAs). For example, LBAs 1-10, LBAs 11-20, LBAs 21-30, and LBAs 31-40 can be stored on data drive 106a of the first data drive 102a, data drive 106b of the second data drive 102b, data drive 106c of the third data drive 102c, and data drive 106d of the fourth data drive 102d, respectively. The subsequent data block can rotate to the first data drive 102a again. For example, LBAs 41-50, LBAs 51-60, LBAs 61-70, and LBAs 71-80 can be stored on data drive 108a of the first data drive 102a, data drive 108b of the second data drive 102b, data drive 108c of the third data drive 102c, and data drive 108d of the fourth data drive 102d, respectively. In this manner, the data blocks can be stored in rows, each row including a disk included in a data drive.

As shown in FIG. 1, each row additionally includes a disk included in a parity drive. For example, the first row that includes the data drive 106a, the data drive 106b, the data drive 106c, and the data drive 106d also includes the disk 110 in the parity drive 104. Similarly, the second row that includes the data drive 108a, the data drive 108b, the data drive 108c, and the data drive 108d also includes the disk 112 in the parity drive 104.

Striping combines several disk storage drives and a parity disk in a parity drive into a single volume. A stripe, therefore, identifies a combination of data drives in a data drive together with a parity drive. For example, a first stripe 120a identifies the data drive 106a, the data drive 106b, the data drive 106c, the data drive 106d, and the parity disk 110. A second stripe 120b identifies the data drive 108a, the data drive 108b, the data drive 108c, the data drive 108d, and the parity disk 112. The RAID array 100 can be identified by multiple stripes (for example, the first stripe 120a, the second stripe 120b, and so on until the nth stripe 120n). In some implementations, a stripe can identify multiple rows, each row including data drives in the data drives and a corresponding parity disk in the parity drive. The write hole avoidance techniques described in this specification can be implemented either on stripes that include only one row identifying data drives and a parity disk or on stripes that multiple rows, each identifying data drives and corresponding parity disks or both.

Example Technique for Writing a Parity Data to a Parity Drive

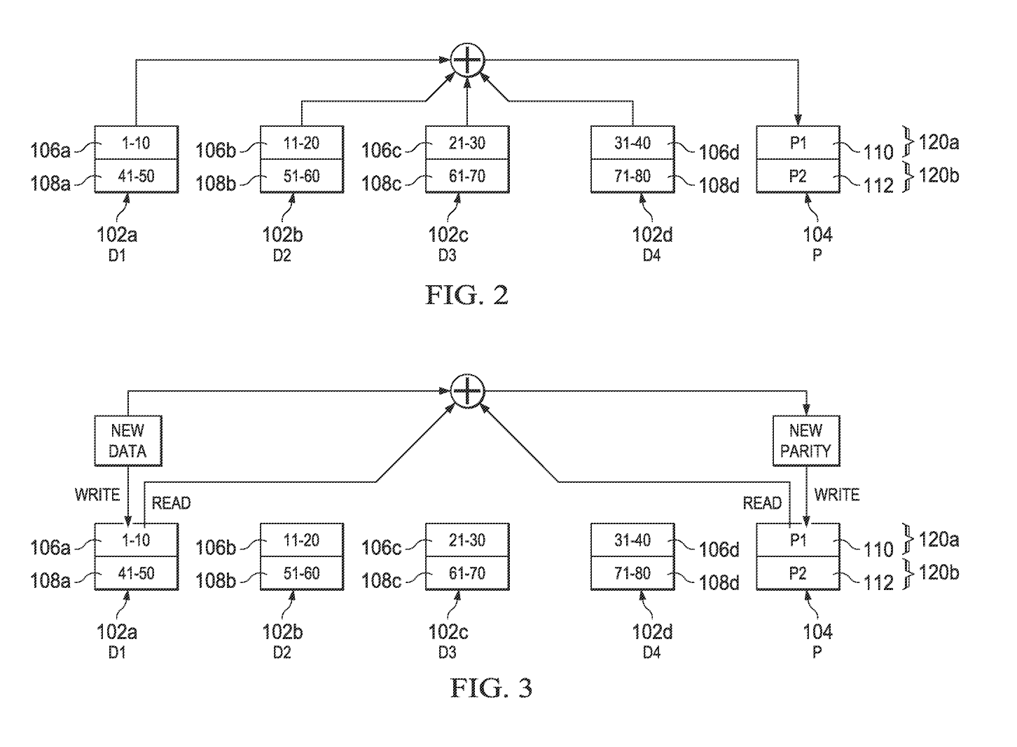

FIG. 2 is a schematic diagram showing determination of the parity data to be written to the parity drive of the RAID array of FIG. 1. In some implementations, the determination of the parity data can be implemented by a RAID controller, for example, the RAID controller 105.

As described above, the first stripe 120a identifies the data drive 106a, the data drive 106b, the data drive 106c, the data drive 106d, and the parity disk 110. Also, blocks of data identified by LBAs can be written to the data drives. For example, LBAs 1-10, LBAs 11-20, LBAs 21-30, and LBAs 31-40 can be stored on data drive 106a of the first data drive 102a, data drive 106b of the second data drive 102b, data drive 106c of the third data drive 102c, and data drive 106d of the fourth data drive 102d, respectively. The data to be written to the parity disk 110 in the parity drive 104 is obtained by performing XOR operations on the data stored in each disk in the first stripe 120a as shown in Equation 1.

P1(110)=D(106a)XOR D(106b)XOR D(106c)XOR D(106d) (Eq.1)

Similarly, the second stripe 120b identifies the data drive 108a, the data drive 108b, the data drive 108c, the data drive 108d, and the parity disk 112. Also, LBAs 41-50, LBAs 51-60, LBAs 61-70, and LBAs 71-80 can be stored on data drive 108a of the first data drive 102a, data drive 108b of the second data drive 102b, data drive 108c of the third data drive 102c, and data drive 108d of the fourth data drive 102d, respectively. The data to be written to the parity disk 112 in the parity drive 104 is obtained by performing XOR operations on the data stored in each disk in the second stripe 120b as shown in Equation 2.

P1(112)=D(108a)XOR D(108b)XOR D(108c)XOR D(108d) (Eq.2)

FIG. 3 is a schematic diagram showing updating a parity data in a parity drive in the RAID array of FIG. 1. In some implementations, blocks of data stored in a data storage drive can be overwritten (for example, in response to a new write command). For example, the data written in data drive 106a can be overwritten using new data. In such implementations, the parity data stored in the parity disk 110 identified by the first stripe 120a needs to be updated for parity consistency. One technique to update the parity data is to perform XOR operations on the data stored in each disk identified by the first stripe 120a as shown in Equation 1 above. Because Equation 1 will be implemented using the new data in the data drive 106a, the parity data in the parity disk 110 will also be updated. Another technique to update the parity data is to perform XOR operations on the new data to be written to the data drive 106a, the existing data written on the data drive 106a, and the existing parity data written on the parity disk 110.

Example Technique of Checking for Parity Consistency

The latter technique described above is faster than the former because the write operation is not an atomic write operation; rather, it is a read-modify-write operation which can fail prior to completion, for example, due to power failure. For example, the command to write the new data to the data drive 106a and to write the new parity data to the parity disk 110 can be issued at the same time. However, the respective drives can execute the two commands at different times. In such situations, one of the data drive 106a or the parity disk 110 can have been updated, but the other need not have been updated at a time instant at which power failure occurs.

A parity consistency check can be performed to determine whether the parity data in a parity drive identified by a stripe is consistent with the data in the data drives identified by that stripe. That is, a stripe can be determined as being parity-consistent if a result of XOR operations performed on data written on the data drives identified by the stripe is equal to the parity data written on the parity disk identified by that stripe. Otherwise, the stripe can be determined as being parity-inconsistent. A parity-inconsistent stripe can be made parity-consistent by reading the data in the disk storage drives, performing XOR operations on the read data to recreate the parity data, and writing the effect-created parity data to the stripe's parity drive. In some implementations, a RAID controller, for example, the RAID controller 105, can perform the parity consistency check, determining a stripe as being parity-inconsistent, or making a parity-inconsistent stripe to be parity-consistent.

Example Technique for Recovering Data

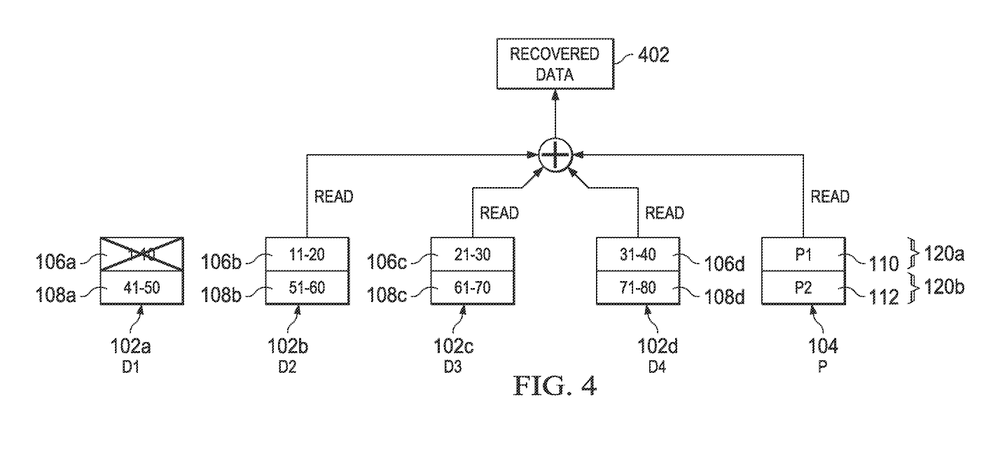

FIG. 4 is a schematic diagram showing recovering data in a disk drive in the RAID array of FIG. 1. When a stripe is parity-consistent, data that was previously written on a failed data drive can be recovered. For example, if the first data drive 102a fails, and the stripe 120a is parity-consistent, then the data that was previously written to the data drive 106a can be recovered by performing XOR operations on the data written to the data drive 106b, the data drive 106c, the data drive 106d, and the parity data stored in the parity disk 110, and writing the recovered data 402 on the data drive 106a. Similarly, if the stripe 120b is parity-consistent, then the data that was previously written to the data drive 108a can be recovered by performing XOR operations on the data written to the data drive 108b, the data drive 108c, the data drive 108d, and the parity data stored in the parity disk 112, and writing the recovered data on the data drive 108a. However, if a stripe is not parity-consistent, then data cannot be recovered using the XOR operations described above. This is the write hole effect.

Parity-Inconsistent Table to Overcome Write Hole Effect

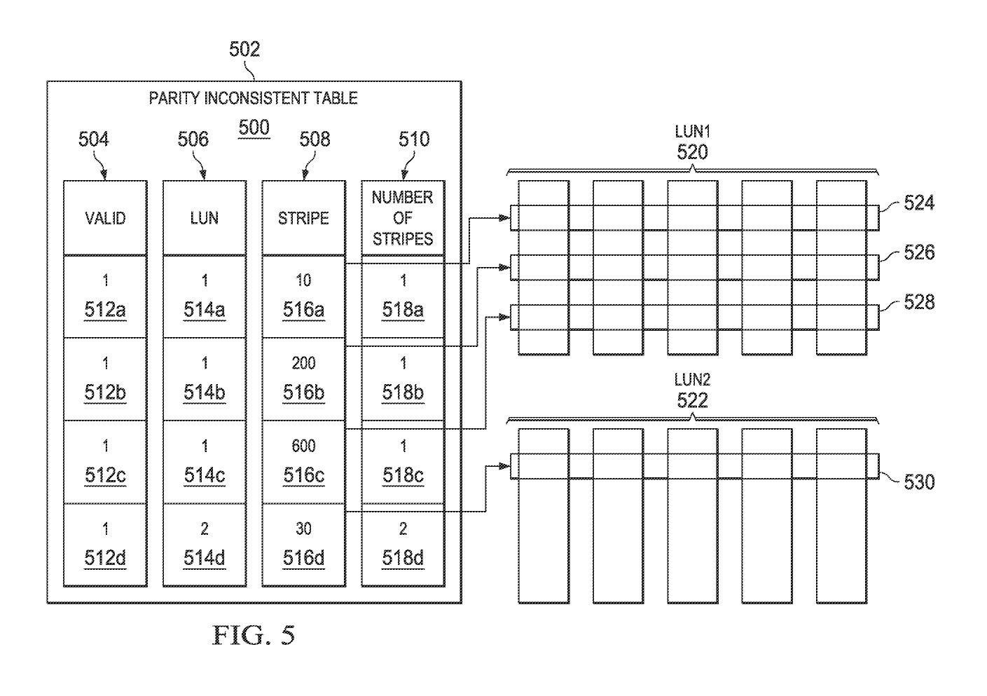

FIG. 5 is a schematic diagram of a parity-inconsistent table 500 implemented to address a write hole effect in the RAID array of FIG. 1. The parity-inconsistent table 500 is stored on a memory 502 that can survive a power loss, for example, a non-volatile random access memory (NVRAM) or a non-volatile static random access memory (NVSRAM). The parity-inconsistent table 500 includes a logical unit number (LUN) column 506. Each row in the LUN column 506 (for example, a first LUN row 514a, a second LUN row 514b, a third LUN row 514c, a fourth LUN row 514d, or more or fewer LUN rows) can identify a LUN to which the stripe belongs. The parity-inconsistent table 500 also includes a stripe column 508. Each row in the stripe column 508 (for example, a first stripe row 516a, a second stripe row 516b, a third stripe row 516c, a fourth stripe row 516d, or more or fewer stripe rows) can identify a specific stripe included in the data drive identified by the corresponding LUN row. The parity-inconsistent table 500 also includes a number of stripes column 510. Each row in the number of stripes column 510 (for example, a first row 518a, a second row 518b, a third row 518c, a fourth row 518d, or more or fewer rows) can identify a number of continuous stripes included in the row identified by the corresponding stripe row.

For example, each of the LUN rows 514a, 514b, and 514c identifies the data drive represented by the first LUN 520 (“LUN 1” in FIG. 5). LUN row 514d identifies the data drive represented by the second LUN 522 (“LUN 2” in FIG. 5). The first stripe row 516a, the second stripe row 516b, and the third stripe row 516c identify stripes 10, 200, and 600, respectively, in the data drive represented by the first LUN 520. The fourth stripe row 516d identifies stripe 30 in the data drive represented by the second LUN 522. As described above, a stripe can include one or more rows, each row including data drives in the data drives and a corresponding parity disk in the parity drive. For example, stripe 10 in the data drive represented by the first LUN 520 (stripe 524) can include one row. Similarly, stripes 200 and 600 in the data drive represented by the first LUN 520 (stripe 526 and stripe 528) can also include one row. Consequently, the corresponding row in the number of stripes column 510 (the first row 518a, the second row 518b, and the third row 518c) stores “1,” denoting that the each of the stripes identified by the corresponding stripe row includes one row. In another example, stripe 30 in the data drive represented by the second LUN 522 (stripe 530) can include two rows. Consequently, the corresponding row in the number of stripes column 510 (the fourth row 518d) stores “2,” denoting that the stripe identified by the corresponding stripe row includes two rows.

In some implementations, the parity-inconsistent table 500 can include a validity column 504. As described below, entries in a row in the parity-inconsistent table 500 are set prior to executing a write command and are erased after the write command has been successfully executed. The validity column 504 can include multiple rows (for example, a first row 512a, a second row 512b, a third row 512c, a fourth row 512d, or more or fewer rows). An entry in a row in the validity column 504 can be “1” (or other “Yes” or “On” indicator) when a write command to write data to a stripe identified by a row in the stripe column 508 is in progress. The entry in the row in the validity column 504 can be “0” (or other “No” or “Off” indicator) when the write command has been successfully executed. Alternatively, the entry with validity column “0” can be reused by another write command. In this manner, the size of the parity-inconsistent table 500 can be limited to include only those stripes to which data is being written.

Example Process to Avoid Write Hole Effect Using Parity-Inconsistent Table

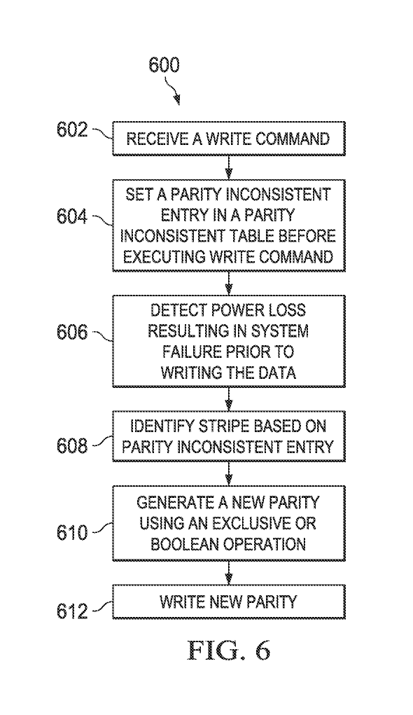

FIG. 6 is a flowchart of an example of a process 600 of solving a write hole effect in a RAID array. In some implementations, the process 600 can be implemented by a RAID controller, for example, the RAID controller 105. The controller can be connected to each data drive and to each parity drive in the RAID array, and can be configured to execute instructions to perform operations including writing data blocks to the disks in the data drives, determining parity data and parity inconsistencies (for example, by performing XOR operations), and fixing parity inconsistencies using the parity-inconsistent table. When data is written to the RAID array for the first time, parity initialization in the first instance, i.e., the determination of parity data to be written to the parity drives, will be performed for the first time. The process 600 can be implemented after parity initialization in the first instance has been completed.

At 602, a write command is received. For example, the controller can receive one or more write commands from a host. Each write command can include a command to write blocks of data to multiple disks in the data drives in the RAID array and to write parity data in corresponding parity disks in the parity drive in the RAID array. The controller can be configured to process a certain number of write commands at a time, for example, 1024 write commands. In addition, although the host issues the multiple commands at the same time, the controller may not process all write commands simultaneously. For example, when the host issues a maximum number of write commands that the controller is configured to execute, the controller can process the write commands in batches (for example, 1 at a time, 2 at a time, 10 at a time). Moreover, for each command, the controller may first process the command to write blocks of data to the disks in the data drives and then process the command to write parity data in the parity drive.

At 604, a parity-inconsistent entry is set in a parity-inconsistent table before executing the write command. For example, in response to receiving the one or more write commands, the controller can set parity entries in the parity-inconsistent table before executing the write command. From the write command, the controller can identify a LUN number representing a data drive in which blocks of data are to be written, a stripe in which the blocks of data are to be written, and a number of rows in the stripe. In response to the identification, the controller can set corresponding parity entries in the parity-inconsistent table. Turning to the example described above with reference to FIG. 5, the controller can set a LUN number of “1” in the LUN row 514a, set the stripe number to “10” in stripe row 516a, and set the row 518a to “1” in the number of stripes column 510. After setting the parity entries in the parity-inconsistent table, the controller can execute the write command to write the blocks of data to the data drives identified by the LUN number, specifically to the identified stripe.

As described above, the controller can be configured to execute write commands in batches (for example, 1 at a time, 2 at a time, 10 at a time). The controller can complete executing a write command for a first batch before commencing a write command for a second batch. In such instances, a number of entries in the parity-inconsistent table can equal a number of write commands that the controller can execute in a batch. In instances in which the write command has been successfully executed, the host can return a write complete command. In response, the controller can free the written entries. That is, the controller can delete the entries in the parity-inconsistent table or set the validity column for those entries to “0” (or a similar “No” or “Off” indicator). If, on the other hand, the host has not returned a write complete command, then the write command has not yet been successfully executed. A system crash (for example, due to power loss) will result in a write hole effect.

At 606, a system crash prior to writing the data is detected. For example, the system crash can result due to a power loss or crashing system failure or a RAID control crash. The system crash results in the blocks of data not being written to some of the stripes in the RAID array. Consequently, parity inconsistencies result in those stripes. When the controller restarts, then the controller needs to identify and fix the parity inconsistencies before bringing the RAID array online and making the RAID array available to the host. As described earlier, each entry in the parity-inconsistent table is an indication that the write commands to a stripe identified in each entry were not successfully completed. That is, parity inconsistencies exist only in those stripes identified in the parity-inconsistent table. Thus, to identify the stripes in which parity inconsistencies exist, the controller need only read the parity-inconsistent table rather than perform a parity inconsistency check for each stripe in the RAID array.

A RAID array can have a large number of disks. In comparison, a number of entries in the parity-inconsistent table will be small. For example, the controller can support a fixed number of write commands (for example, 1024 write commands) at a time. Thus, in response to receiving the write command from the host, the controller may have created at most 1024 parity entries in the parity-inconsistent table. When a system crash occurs, the controller can identify the stripes with parity inconsistencies by reading the parity-inconsistent table instead of performing parity inconsistency checks in the comparatively larger number of stripes in the RAID array. In this manner, the controller can have identified stripes in which parity inconsistencies may occur even before executing the write command, thereby decreasing an amount of time needed to fix the parity inconsistencies.

At 608, a stripe can be identified based on a parity-inconsistent entry. For example, upon restart following a power loss or a data drive crash, the controller can examine the parity-inconsistent table to identify entries. An entry in the parity-inconsistent table indicates that the write command was not successfully completed for the stripe identified for the entry. Had the write command been successfully completed for the stripe, the entry would have been removed from the parity-inconsistent table.

At 610, a new parity is generated for the stripe. For example, the controller can perform a Boolean XOR operation on the data in the data blocks in the stripe identified by the entry in the parity-inconsistent table, resulting in new parity data being generated for the stripe. The controller can perform similar Boolean XOR operations for each stripe identified by the entries in the parity-inconsistent table. In instances in which the stripe includes one row (for example, as identified by the row in the number of stripes column 510), the controller can generate new parity only for one row. In instances in which the stripe includes multiple rows, the controller can generate new parities for the multiple rows in the stripe.

At 612, the new parity is written. For example, the controller can write the new parity to the corresponding parity disk in the parity drive, the parity disk included in the stripe. In response to and after writing the new parity to the parity disk, the controller can delete the entry from the parity-inconsistent table.

Implementations of the subject matter and the operations described in this specification can be implemented as a controller including digital electronic circuitry, or computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a controller on data stored on one or more computer-readable storage devices or received from other sources.

The controller can include one or more data processing apparatuses to perform the operations described here. The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Thus, particular implementations of the subject matter have been described. Other implementations are within the scope of the following claims.

1. A method performed by a redundant array of independent disks (RAID) controller, the method comprising:
following a system crash in a redundant array of independent disks (RAID), retrieving, by the controller and from a table, information identifying at least one stripe from among a plurality of stripes in the RAID, wherein data was to be written to the at least one stripe in response to a write command and prior to the system crash, the information identifying respective data arrays and a respective parity drive identified by the at least one stripe, the information generated and written to the table prior to writing the data to the respective data arrays and the respective parity drive identified by the at least one stripe and prior to the system crash;
for the identified at least one stripe, determining, by the controller, parity data using data stored in the respective data arrays identified by the stripe; and
writing the determined parity data to the parity drive identified by the stripe.

2. The method of claim 1, wherein the plurality of stripes identify a plurality of data arrays including a parity drive array, each array distributed across a plurality of disks in the RAID, and wherein the data arrays and the respective parity drive identified by the at least one stripe are a proper subset of data arrays and a proper set of parity drives of the plurality of data arrays.

3. The method of claim 1, wherein, for the identified at least one stripe, determining, using data stored in the respective data arrays, the parity data that was to be written to the respective parity drive in response to the write command and prior to the system crash comprises:
identifying data stored in the respective data arrays;
performing exclusive OR Boolean operations on the identified data; and
writing a result of the exclusive OR Boolean operations to the respective parity drive.

4. The method of claim 1, wherein the information identifying the at least one stripe comprises at least one of a logical unit number (LUN) or a stripe number identifying the at least one stripe.

5. The method of claim 4, wherein the at least one stripe comprises at least two stripes, and wherein the information identifying the at least two stripes comprises a number of stripes to which the data was to be written.

6. The method of claim 1, further comprising, prior to the system crash:
receiving the write command;
identifying the at least one stripe to which data is to be written in response to receiving the write command;
generating the information identifying the at least one stripe in response to receiving the at least one stripe;
storing the generated information in the table; and
beginning performance of the write command.

7. The method of claim 6, wherein the generated information is stored prior to beginning performance of the write command.

8. The method of claim 1, wherein the table is stored in non-volatile memory.

9. The method of claim 8, wherein the table is unaffected by the system crash.

10. The method of claim 1, wherein the system crash is caused by power loss while performing the write command.

11. A redundant array of independent disks (RAID) controller configured to perform operations comprising:
following a system crash in a redundant array of independent disks (RAID), retrieving, by the controller and from a table, information identifying at least one stripe from among a plurality of stripes in the RAID, wherein data was to be written to the at least one stripe in response to a write command and prior to the system crash, the information identifying respective data arrays and a respective parity drive identified by the at least one stripe, the information generated and written to the table prior to writing the data to the respective data arrays and the respective parity drive identified by the at least one stripe and prior to the system crash;
for the identified at least one stripe, determining, by the controller, parity data using data stored in the respective data arrays identified by the stripe; and
writing the determined parity data to the parity drive identified by the stripe.

12. The RAID controller of claim 11, wherein the plurality of stripes identify a plurality of data arrays including a parity drive array, each array distributed across a plurality of disks in the RAID, and wherein the data arrays and the respective parity drive identified by the at least one stripe are a proper subset of data arrays and a proper set of parity drives of the plurality of data arrays.

13. The RAID controller of claim 11, wherein, for the identified at least one stripe, determining, using data stored in the respective data arrays, the parity data that was to be written to the respective parity drive in response to the write command and prior to the system crash comprises:
identifying data stored in the respective data arrays;
performing exclusive OR Boolean operations on the identified data; and
writing a result of the exclusive OR Boolean operations to the respective parity drive.

14. The RAID controller of claim 11, wherein the information identifying the at least one stripe comprises at least one of a logical unit number (LUN) or a stripe number identifying the at least one stripe.

15. The RAID controller of claim 14, wherein the at least one stripe comprises at least two stripes, and wherein the information identifying the at least two stripes comprises a number of stripes to which the data was to be written.

16. A storage system comprising:
a redundant array of independent disks (RAID); and
a controller connected to the RAID, the controller configured to perform operations comprising:
following a system crash in a redundant array of independent disks (RAID), retrieving, by the controller and from a table, information identifying at least one stripe from among a plurality of stripes in the RAID, wherein data was to be written to the at least one stripe in response to a write command and prior to the system crash, the information identifying respective data arrays and a respective parity drive identified by the at least one stripe, the information generated and written to the table prior to writing the data to the respective data arrays and the respective parity drive identified by the at least one stripe and prior to the system crash;
for the identified at least one stripe, determining, by the controller, parity data using data stored in the respective data arrays identified by the stripe; and
writing the determined parity data to the parity drive identified by the stripe.

17. The system of claim 16, wherein the plurality of stripes identify a plurality of data arrays including a parity drive array, each array distributed across a plurality of disks in the RAID, and wherein the data arrays and the respective parity drive identified by the at least one stripe are a proper subset of data arrays and a proper set of parity drives of the plurality of data arrays.

18. The system of claim 16, wherein, for the identified at least one stripe, determining, using data stored in the respective data arrays, the parity data that was to be written to the respective parity drive in response to the write command and prior to the system crash comprises:
identifying data stored in the respective data arrays;
performing exclusive OR Boolean operations on the identified data; and
writing a result of the exclusive OR Boolean operations to the respective parity drive.

19. The system of claim 16, wherein the information identifying the at least one stripe comprises at least one of a logical unit number (LUN) or a stripe number identifying the at least one stripe.

20. The system of claim 19, wherein the at least one stripe comprises at least two stripes, and wherein the information identifying the at least two stripes comprises a number of stripes to which the data was to be written.
